(19) United States
(12) Patent Application Publication
(10) Pub. No.: US 2019/0160985 A1
(43) Pub. Date: May 30, 2019

(54) Linear Actuating Assemblies for Motorized Headrests

(71) Applicant: Dare Auto, Inc., Plymouth, MI (US)

(72) Inventors: Mingguang Yu, West Bloomfield, MI (US); Hao Cheng, Novi, MI (US); Liang Yang, Canton, MI (US); Christine Diane Obradovich, Livonia, MI (US)

(73) Assignee: Dare Auto, Inc., Plymouth, MI (US)

(21) Appl. No.: 15/826,144

(22) Filed: Nov. 29, 2017

(51) Int. Cl. B60N 2/48

(52) U.S. Cl. CPC B60N 2/4829; B60N 2/4867

(57) ABSTRACT

A linear actuating assembly for a headrest having a fixed portion and a moveable portion configured to support a user's head. The linear actuating assembly comprising a stator fixedly connectable to the fixed portion of the headrest, a rotor circumferentially surrounding the stator, a shaft extending axially through the stator and the rotor, and a nut connected to a threaded portion of the shaft and fixedly connectable to the moveable portion of the headrest. The shaft is fixedly connected to Rotation of the rotor causes linear movement of the nut along the threaded portion of the shaft, thereby moving the moveable portion of the headrest relative to the fixed portion of the headrest.

### TECHNICAL HELD

This disclosure relates generally to linear actuating assemblies, and more particularly, to linear actuating assemblies for motorized headrests.

### BACKGROUND

Chairs or seats, such as automobile seats, can be provided with adjustable headrests, which allows the same chair or seat to accommodate different-sized occupants. The adjustment can be performed manually by the occupant or by a motor. While motorized adjustment provides fine-tuning of the headrest's position that is difficult to achieve manually, the use of the motor can introduce unwanted noise and/or vibration while the motor is being operated.

### SUMMARY

Linear actuating assemblies are disclosed herein. In a first implementation, a linear actuating assembly for a headrest having a moveable portion and a fixed portion. The linear actuating assembly comprises a stator fixedly connectable to the fixed portion of the headrest, a rotor circumferentially surrounding the stator, a shaft extending axially through the stator and the rotor, and a nut connected to a threaded portion of the shaft and fixedly connectable to the moveable portion of the headrest. The shaft is fixedly connected to the rotor. Rotation of the rotor causes linear movement of the nut along the threaded portion of the shaft, thereby moving the moveable portion of the headrest relative to the fixed portion of the headrest.

The rotor can drive rotation of the shaft without use of a gear box. A radial wall of a rotor can circumferentially surround the stator. The shaft can be connected to a wall of the rotor, and the rotor and the shaft can rotate in unison. The stator, the rotor, the shaft, the nut, and the radial wall of the rotor can be coaxially aligned. The linear actuating assembly can include a base opposite the wall of the rotor, and the base can be fixedly connected to the stator.

In a second implementation, a motorized headrest comprising a fixed portion, a moveable portion adapted to support a head of an occupant, a first motor, and a first nut fixedly connected to the moveable portion. The first motor has a first stator fixedly connected to the fixed portion, a first rotor circumferentially surrounding the first stator, and a first shaft extending axially through the first stator and fixedly connected to the first rotor. The first nut is connected to a first threaded portion of the first shaft. Rotation of the first rotor of the first motor causes linear movement of the moveable portion relative to the fixed portion in a first direction.

The motorized headrest can include a second motor and a second nut fixedly connected to the moveable portion. The second motor has a second stator fixedly connected to the fixed portion, a second rotor circumferentially surrounding the second stator, and a second shaft extending axially through the second stator and fixedly connected to the second rotor. The second nut is connected to a second threaded portion of the second shaft. Rotation of the second rotor of the second motor causes linear movement of the moveable portion relative to the fixed portion in a second direction.

The first direction and the second direction can be substantially perpendicular to one another. At least one of the first motor or the second motor can be a brushless direct current electric motor. The first rotor can drive rotation of the first shaft without use of a gearbox, and the second rotor can drive rotation of the second shaft without use of a gearbox. The first stator, the first rotor, the first shaft, and the first nut of the first motor can be coaxially aligned about a first axis. The second stator, the second rotor, the second shaft, and the second nut of the second motor can be coaxially aligned about a second axis. The first axis and the second axis can be substantially perpendicular to one another. The fixed portion and the moveable portion can be generally parallel to one another and spaced apart in the first direction. The fixed portion can be connected to a back of a seat, and the seat can extend generally in the second direction.

The motorized headrest can include a first support post extending out from a wall of the fixed portion. The first support post can be substantially parallel to the first shaft and substantially perpendicular to the second shaft. The motorized headrest can include a second support post connecting the moveable portion to the fixed portion. The second support post can be substantially perpendicular to the first shaft and substantially parallel to the second shaft.

In a third implementation, a motorized headrest comprising a moveable portion adapted to support a head of an occupant, a fixed portion having a hollow region with a first support post extending within, a sled slidably mounted to the first support post within the hollow region of the fixed portion, a first motor, and a second motor. The first motor has a first stator fixedly connected to the fixed portion, a first rotor circumferentially surrounding the first stator, a first shaft fixedly connected to the first rotor, and a first connector fixedly connected to the sled. The first connector has a first nut connected to a first threaded portion of the first shaft. Rotation of the first rotor of the first motor around the first stator causes linear movement of the sled along the first support post in a first direction. The second motor has a second stator fixedly connected to the sled, a second rotor circumferentially surrounding the second stator, a second shaft fixedly connected to the second rotor, and a second connector fixedly connected to the moveable portion. The second connector has a second nut connected to a second threaded portion of the second shaft. Rotation of the second rotor of the second motor around the second stator causes linear movement of the fixed portion in a second direction.

The first direction can be substantially perpendicular to the second direction. At least one of the first motor or the second motor can be a brushless direct current motor. The motorized headrest can include a second support post fixedly connected to the moveable portion and slidably connected to the sled.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a side perspective view of an automobile seat.

FIG. 2 is a side plan view of a headrest for the automobile seat.

FIG. 3 is a cutaway, rear plan view of the headrest along line 3-3 of FIG. 2.

FIG. 4 is a side plan view of a linear actuating assembly.

FIG. 5 is an exploded perspective view of the linear actuating assembly.

FIG. 6 is a cross-sectional view of the linear actuating assembly.

### DETAILED DESCRIPTION

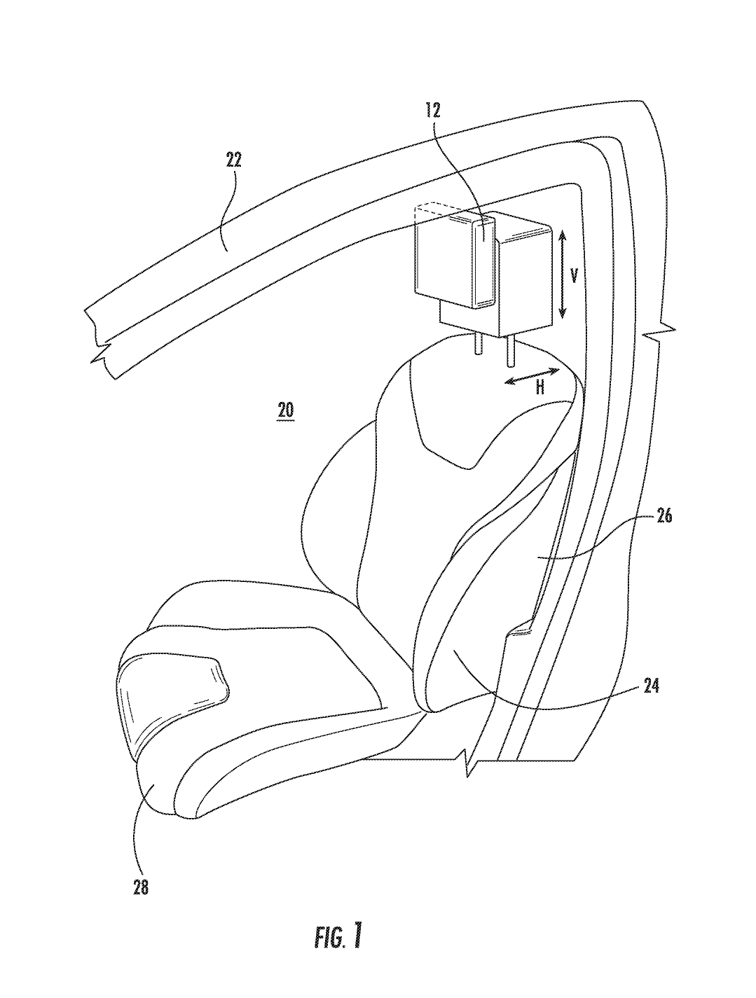

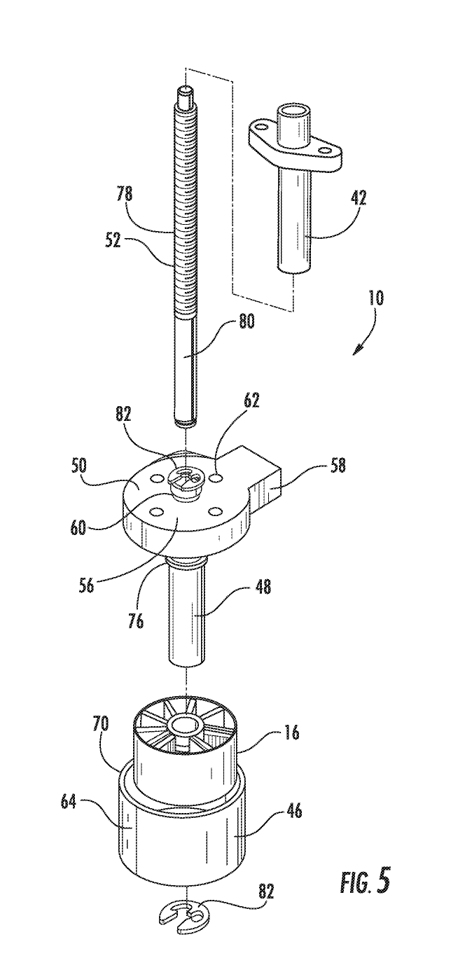

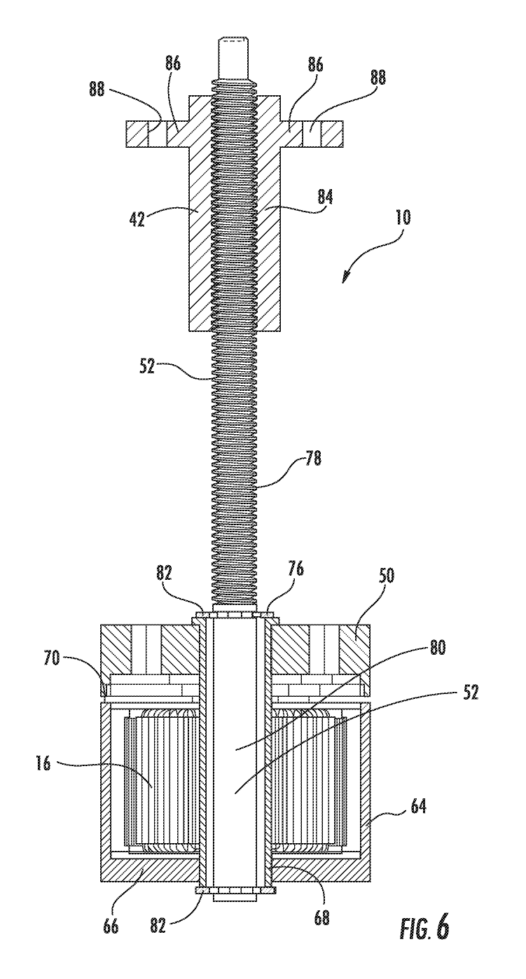

FIGS. 1-6 illustrate a linear actuating assembly 10 that can be used in a headrest 12 to provide linear adjustment of the headrest 12. As will be explained, the linear actuating assembly 10 uses a rotor 46 that surrounds a stator 16, instead of the stator 16 surrounding the rotor 46, which allows the rotor 46 to directly drive linear movement of the headrest 12 in a 1:1 drive ratio without the use of a gear box. By eliminating the gear box, the noise, vibration, and harshness performance of the linear actuating assembly 10 is improved. The linear actuating assembly 10 also extends the use of brushless direct current motors to headrest applications.

An exemplary automobile seat 18 positioned within an interior 20 of an automobile 22 is illustrated in FIG. 1. Although the exemplary automobile seat 18 is on a driver's side 24 of the automobile 22, the automobile seat 18 could be located elsewhere in the automobile 22, such as on a passenger's side, in a middle row, or in a rear row. The automobile seat 18 has a seat back 26 pivotally or fixedly connected to a seat member 28. The seat member 28 and the seat back 26 are configured to comfortably support an occupant (not shown) of the automobile 22.

The headrest 12 extends generally vertically from the seat back 26 and be configured to support a head (not shown) of the occupant. To assist with supporting the occupant's head, the headrest 12 can be configured to provide linear adjustment of the headrest 12 in at least one direction, For example, the headrest 12 could be moved vertically, horizontally, and/or laterally in relation to the seat back 26 to accommodate the needs of different sized occupants. The adjustment of the headrest 12 is performed manually by the occupant or by activation of a motor. In the illustrated, non-limiting example, the headrest 12 is provided with two linear actuating assemblies 10A, 10B that provide motorized adjustment in two directions. One of the linear actuating assemblies 10A provides motorized adjustment of the headrest 12 in a vertical direction V, and the other linear actuating assembly 10B provides motorized adjustment of the headrest 12 in a horizontal direction H.

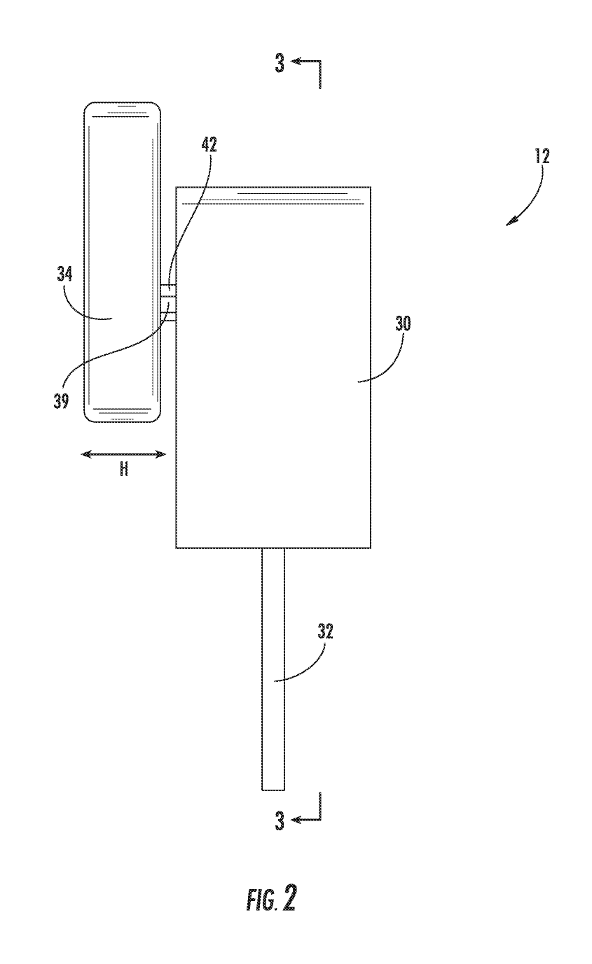

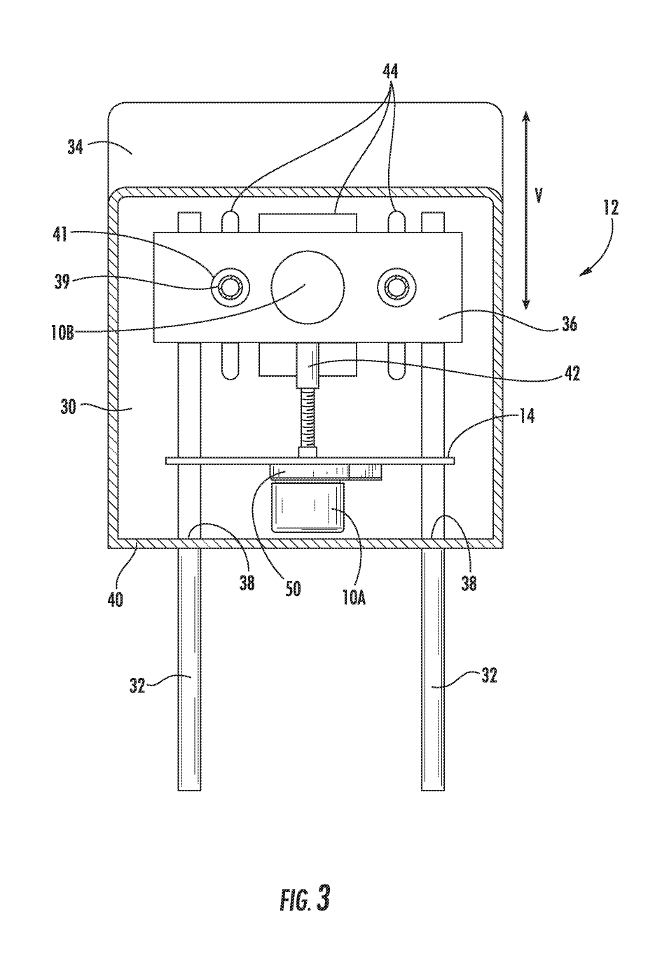

A fixed portion 30 of the headrest 12 is fixedly connected to the seat back 26 via vertical support posts 32, and a moveable portion 34 of the headrest 12 is moveable in relation to the fixed portion 30, as shown in FIGS. 2-3. The fixed portion 30 and the moveable portion 34 can have substantially cuboid configurations as shown or any other suitable configuration. The moveable portion 34 can be padded to provide comfort when the occupant's head is rested against the headrest 12.

The fixed portion 30 of the headrest 12 is hollow to allow the fixed portion 30 to house the linear actuating assemblies 10, a sled 36, and portions of the vertical support posts 32. The vertical support posts 32 extend substantially parallel with one another through the fixed portion 30 of the headrest 12 into the seat back 26 of the automobile 22. (not shown). The fixed portion 30 can be provided with apertures 38 extending through a bottom wall 40 to allow the vertical support posts 32 to extend into the fixed portion 30 of the headrest 12. The sled 36 can be slidably connected to the vertical support posts 32.

To provide adjustment of the moveable portion 34 of the headrest 12 in the vertical direction V, one of the linear actuating assemblies 10A can have one end (e.g., a motor end) fixedly connected directly to the fixed portion 30 of the headrest 12 and another end (e.g., a nut end) fixedly connected to the sled 36 via a connector 42. The other linear actuating assembly 10B can have one end (e.g., a motor end) fixedly connected directly to the sled 36 and the other end (e.g., a nut end) fixedly connected to the moveable portion 34 of the headrest 12 via a connector 42 to provide adjustment of the moveable portion 34 of the headrest 12 in the horizontal direction H. The headrest 12 can be provided with horizontal support posts 39 that can slide into and out of respective apertures 41 extending substantially horizontal through the sled 36 to provide additional support and prevent the fixed portion 30 of the headrest 12 from rotating around the linear actuating assembly 10B. The fixed portion 30 of the headrest 12 can be provided with apertures 44 that allow the connector 42 and the horizontal support posts 39 to extend out of the fixed portion 30 to the moveable portion 34 of the headrest 12.

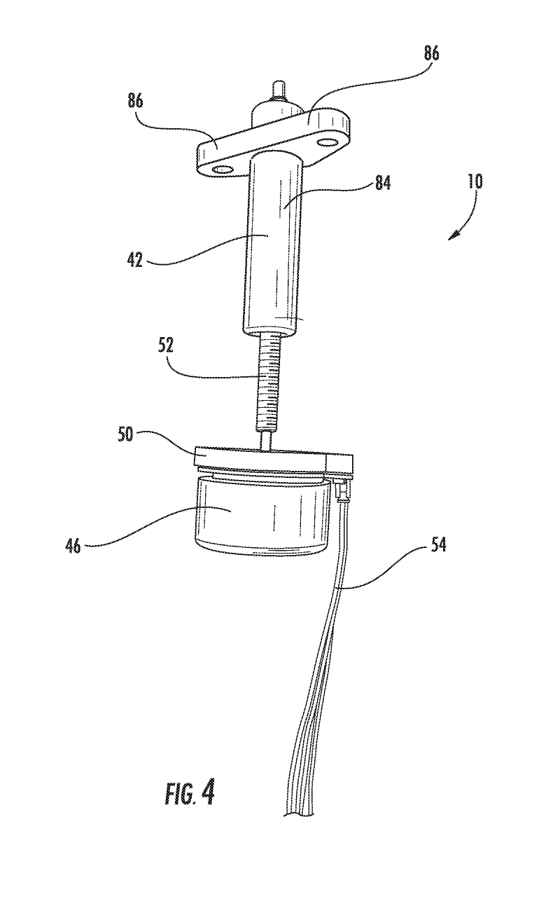

FIGS. 4-6 illustrate the linear actuating assemblies 10, which are lead screw actuators. Each linear actuating assembly 10 includes the rotor 46, the stator 16, a bushing 48, a base 50, a shaft 52, electric wiring 54, and the connector 42. When the linear actuating assembly 10 is within the headrest 12, the base 50 is fixedly mounted within and to the fixed portion 30 of the headrest 12.

As shown, a body 56 of the base 50 has a disc-like configuration that is generally complementary to the rotor 46. A flange 58 can extend from the body 56 of the base 50, which allows the electric wiring 54 to be connected to the base 50 without interfering with rotation of the rotor 46 below the base 50. A first aperture 60 and second apertures 62 can extend through the body 56 of the base 50. The first aperture 60 can be centrally located with the second apertures 62 spaced circumferentially around the first aperture 60. The second apertures 62 can receive fasteners (not shown), which can be used to mount the base 50 to the fixed portion 30 of the headrest 12.

The rotor 46 of the linear actuating assembly 10 can have a cup-like configuration with a radial wall 64 extending substantially perpendicularly along an outer periphery of a bottom wall 66. The radial wall 64 can contain permanent magnets (not labeled). The bottom wall 66 can have a disc-like configuration with an aperture 68 extending through a center of the bottom wall 66. The rotor 46 can have an opening 70 on an end opposite the bottom wall 66, which allows the rotor 46 to receive and house the stator 16.

The stator 16 can include an aperture 72 extending axially through a center of the stator 16 and pairs of coils 74 that can alternately receive direct current from the electric wiring 54. The aperture 72 extending through the stator 16 can be sized to receive the bushing 48, which in turn is sized to accommodate the shaft 52 extending through the bushing 48 and the stator 16.

The bushing 48 can have a substantially tubular configuration with a lip 76 on one end to rest against the base 50. The shaft 52 can have an elongated configuration with a threaded portion 78 that extends out of and away from the base 50. In the illustrated, non-limiting example, the shaft 52 also has a smooth portion 80 opposite the threaded portion 78 where the shaft 52 extends through the bushing 48. The shaft 52, the first aperture 60 of the base 50, the bushing 48, the rotor 46, the aperture 72 of the stator 16, and the aperture 68 of the rotor 46 can be coaxially aligned. Two clips 82 can be used to secure the shaft 52 to the bushing 48 and the rotor 46 so that rotation of the rotor 46 around the stator 16 causes rotation of the shaft 52.

In the illustrated, non-limiting example, the connector 42 has a substantially T-shaped configuration and is comprised of a nut 84 and two flanges 86. The nut 84 can have an elongated configuration with the flanges 86 extending substantially perpendicular from the nut 84. The flanges 86 can be provided with apertures 88 that can receive fasteners (not shown), which allow the connector 42 to be fixedly connected to the sled 36 or the moveable portion 34 of the headrest 12.

When the linear actuating assemblies 10A, 10B are within the headrest 12, the base 50 of the linear actuating assembly 10A can be mounted to a member 14, such as a plate, within the fixed portion 30 of the headrest 12 so that the base 50 and the rotor 46 are disposed between the member 14 and the bottom wall 40 with the shaft 52 extending upward through an aperture (not shown) in the member 14 toward the sled 36. The member 14 can be fixedly mounted to the vertical support posts 32 so that the member 14 is substantially perpendicular to the vertical support posts 32. The shaft 52 of the linear actuating assembly 10A is substantially parallel to the vertical support posts 32, and the connector 42 of the linear actuating assembly 10A is fixedly connected to the sled 36. The base 50 of the linear actuating assembly 10B can be mounted to the sled 36 within the fixed portion 30 of the headrest 12 so that the base 50 and the rotor 46 are on a side of the sled 36 that is furthest away from the moveable portion 34 with the shaft 52 extending substantially horizontally through an aperture (not shown) in the sled 36 and the aperture 44 of the fixed portion 30. The shaft 52 is substantially parallel to the horizontal support posts 39, and the connector 42 of the linear actuating assembly 10B is fixedly connected to the moveable portion 34 of the headrest 1.2

When linear adjustment of the headrest 12 is desired, direct current is sent through the electric wiring 54 to alternately activate the pairs of coils 74 of the stator 16, which causes rotation of the rotor 46 because of the interactions between the permanent magnets of the rotor 46 and the pairs of coils 74 of the stator 16. Rotation of the rotor 46 in turn causes rotation of the shaft 52. Because the base 50 is fixedly connected to the fixed portion 30 of the headrest 12 and the moveable portion 34 of the headrest 12 is fixedly connected to the connector 42, the nut 84 of the connector 42 moves linearly along the threaded portion 78 of the shaft 52. By using brushless direct current motors to provide the linear adjustment as described, the rotor 46 directly drives rotation of the shaft 52 without the use of a gear box in a 1:1 drive ratio, and the noise, vibration, and harshness performance of the headrest 12 is improved.

While the linear actuating assembly 10 has been described in connection with certain embodiments, it is to be understood that the linear actuating assembly 10 is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A linear actuating assembly for a headrest having a moveable portion and a fixed portion, the linear actuating assembly comprising:
a stator fixedly connectable to the fixed portion of the headrest;
a rotor circumferentially surrounding the stator;
a shaft extending axially through the stator and the rotor and fixedly connected to the rotor; and
a nut connected to a threaded portion of the shaft and fixedly connectable to the moveable portion of the headrest, wherein rotation of the rotor causes linear movement of the nut along the threaded portion of the shaft, thereby moving the moveable portion of the headrest relative to the fixed portion of the headrest.

2. The linear actuating assembly of claim 1, wherein the rotor drives rotation of the shaft without use of a gear box.

3. The linear actuating assembly of claim 1, wherein a radial wall of the rotor circumferentially surrounds the stator.

4. The linear actuating assembly of claim 3, wherein the shaft is connected to a wall of the rotor, and the rotor and the shaft rotate in unison.

5. The linear actuating assembly of claim 4, wherein the stator, the rotor, the shaft, nut, and the radial wall of the rotor are coaxially aligned.

6. The linear actuating assembly of claim 4, further comprising:
a base opposite the wall of the rotor, wherein the base is fixedly connected to the stator.

7. A motorized headrest comprising:
a fixed portion;
a moveable portion adapted to support a head of an occupant;
a first motor having a first stator fixedly connected to the fixed portion, a first rotor circumferentially surrounding the first stator, and a first shaft extending axially through the first stator and fixedly connected to the first rotor; and
a first nut connected to a first threaded portion of the first shaft and fixedly connected to the moveable portion, wherein rotation of the first rotor of the first motor causes linear movement of the moveable portion relative to the fixed portion in a first direction.

8. The motorized headrest of claim 7, further comprising:
a second motor comprising a second stator fixedly connected to the fixed portion, a second rotor circumferentially surrounding the second stator, and a second shaft extending axially through the second stator and fixedly connected to the second rotor; and
a second nut connected to a second threaded portion of the second shaft and fixedly connected to the moveable portion, wherein rotation of the second rotor of the second motor causes linear movement of the moveable portion relative to the fixed portion in a second direction.

9. The motorized headrest of claim 8, wherein the first direction and the second direction are substantially perpendicular to one another.

10. The motorized headrest of claim 8, wherein at least one of the first motor or the second motor is a brushless direct current electric motor.

11. The motorized headrest of claim 8, wherein the first rotor drives rotation of the first shaft without a gearbox, and the second rotor drives rotation of the second shaft without a gearbox.

12. The motorized headrest of claim 8, wherein the first stator, the first rotor, the first shaft, and the first nut of the first motor are coaxially aligned about a first axis, the second stator, the second rotor, the second shaft, and the second nut of the second motor are coaxially aligned about a second axis, and the first axis and the second axis are substantially perpendicular to one another.

13. The motorized headrest of claim 8, wherein the fixed portion and the moveable portion are generally parallel to one another and spaced apart in the first direction.

14. The motorized headrest of claim 13, wherein the fixed portion is connected to a back of a seat, and the back of the seat extends generally in the second direction.

15. The motorized headrest of claim 8, further comprising:
a first support post extending out from a wall of the fixed portion, wherein the first support post is substantially parallel to the first shaft and substantially perpendicular to the second shaft.

16. The motorized headrest of claim 15, further comprising:
a second support post connecting the moveable portion of the fixed portion, wherein the second support post is substantially perpendicular to the first shaft and substantially parallel to the second shaft.

17. A motorized headrest comprising:
a moveable portion adapted to support a head of an occupant;
a fixed portion having a hollow region with a first support post extending within;
a sled slidably mounted to the first support post within the hollow region of the fixed portion;
a first motor having a first stator fixedly connected to the fixed portion, a first rotor circumferentially surrounding the first stator, a first shaft fixedly connected to the first rotor, and a first connector fixedly connected to the sled and having a nut connected a first threaded portion of the first shaft, wherein rotation of the first rotor of the first motor around the first stator causes linear movement of the sled along the first support post in a first direction; and
a second motor having a second stator fixedly connected to the sled, a second rotor circumferentially surrounding the second stator, a second shaft fixedly connected to the second rotor, and a second connector fixedly connected to the moveable portion and having a second nut connected to a second threaded portion of the second shaft, wherein rotation of the second rotor of the second motor around the second stator causes linear movement of the fixed portion in a second direction.

18. The motorized headrest of claim 17, wherein the first direction is substantially perpendicular to the second direction.

19. The motorized headrest of claim 17, wherein at least one of the first motor or the second motor is a brushless direct current motor.

20. The motorized headrest of claim 17, further comprising:
a second support post fixedly connected to the moveable portion and slidably connected to the sled.
